(19) United States
(12) Patent Application Publication
(10) Pub. No.: US 2009/0243302 A1
(43) Pub. Date: Oct. 1, 2009

(54) Optimized rotor for a wind power plant and wind power plant for mounting on a building

(75) Inventor: Gerd Eisenblaetter, Geretsried (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Gerd Eisenblaetter GmbH, Geretsried (DE)

(21) Appl. No.: 12/398,088

(22) Filed: Mar. 4, 2009

(30) Foreign Application Priority Data
Mar. 5, 2008 (DE) 102008012587.3

(51) Int. Cl. F03D 9/00; F03D 3/06

(52) U.S. Cl. 290/55; 416/243

(57) ABSTRACT

A rotor for a wind power plant for mounting on a building, especially with a vertical rotational axis, comprising a rotor hub and at least one rotor blade, with the rotor blade being arranged to cover the whole surface area and having a substantially rectangular shape, comprising a radially inwardly disposed edge, a radially outwardly disposed edge, a radially extending bottom edge and a radially extending upper edge, with said rotor blade being provided with a twisted arrangement in a spiral fashion about the rotor hub, starting from its bottom edge in the direction of its upper edge. Furthermore, a wind power plant with such a rotor.

The present invention relates to a rotor for a wind power plant with a preferably vertically extending or aligned rotational axis. The invention further relates to a wind power plant for mounting on buildings, especially roof mounting.

Wind power plants for mounting on a building are known from the state of the art. The patent specifications DE 100 07 199 A1 and DE 196 44 890 A1 show such wind power plants (or wind energy converters) whose rotors have a horizontal alignment. The disadvantageous aspect in such wind power plants is a strong dependence on the direction of the wind. Moreover, wind power plants are known from the state of the art whose rotors have a vertical rotational axis, such as described for example in DE 43 31 073 C1 and DE 43 19 291 C1. Wind power plants with a vertical rotational axis for the rotor are substantially independent of the direction of the wind. The disadvantage however is a low efficiency. The improvement in the efficiency in such systems has long been the subject matter of numerous further developments, as described in the introductory part of DE 43 19 291 C1.

The rotors of such wind power plants must have high stability and strength in order to enable them to absorb wind power and centrifugal forces resulting from the rotation. Moreover, the rotors are also subject to oscillations, which is especially critical in cases when the oscillations are in the range of the resonant frequencies of the rotor.

Further requirements are placed on mounting on a building or the roof of a building. The rotors shall be light in a self-explanatory manner. The inflowing wind is accelerated as a result of flow on pitched roofs, so that relatively strong forces act upon both the rotor (as well as on the entire wind power plant), which forces are absorbed by the rotor bearing and need to be carried off to the roof construction. Due to the vertical rotational axis, bearing of the rotor can occur on only one side, which is the bottom end of the rotational axis (facing the roof), while the other end of the rotational axis protrudes from the roof in a non-fastened manner and is arranged with a quasi flying configuration. Moreover, the oscillations of the rotor and wind power plant shall be substantially avoided, which also need to be carried off to the roof construction. Moreover even minimal noises (e.g. whistling sounds by the wind flow or rumbling sounds from the rotor bearing) are undesirable because the noises audibly propagate in the building via the construction of the building.

It is the object of the invention to improve the efficiency for a wind power plant for mounting on a roof. The wind power plant shall further comprise a light and stiff as well as low-oscillating rotor with a preferably vertical rotational axis.

This object is achieved by a rotor according to claim 1. The object is also achieved by a wind power plant according to the supplementary claim. The claims dependent thereon relate to advantageous further developments and embodiments.

The rotor in accordance with the invention comprises a rotor hub which encloses the rotational axis of the rotor or through which the rotational axis passes at least partly, and at least one rotor blade. The rotor blade is arranged to cover the whole surface area, which shall mean that the surface is substantially closed and filled. Furthermore, the rotor blade has a substantially rectangular shape (with this definition of shape relating predominantly to a planar shadow or projected area of the rotor blade), comprising a radially inwardly disposed edge (inside edge), a radially outwardly disposed edge (outside edge), a bottom edge extending radially from the inside to the outside and an upper edge extending radially from the inside to the outside (bottom and upper edge). The directional information “bottom” and “upper” relate to a preferred mounting position of the rotor. The directional information “radially inside” and “radially outside” relate to an imaginary cylinder and its central axis which circumscribes the entire rotor.

The rotor blade is arranged in accordance with the invention to a spiral from its bottom edge in the direction towards the upper edge or in a screw-like or winding manner twisted about the rotor hub. The spiral twisting is especially continuous. Preferably, several rotor blades are provided. Subsequent embodiments therefore relate in a non-limiting manner to a plurality of rotor blades.

Preferably, the rotor in accordance with the invention concerns such a one with vertical rotational axis because the advantages of the invention will show themselves especially clearly. As a result of the spirally twisted arrangement of the rotor blades, the wind accelerated on pitched roofs can be used optimally in the case of roof mounting because the rotor blades face the wind flow especially with their upper surface sections, thus significantly increasing the efficiency. The simultaneously rectangular arrangement of the rotor blades causes in each rotor blade a homogeneous distribution of force and pressure over the rotor blade surface, resulting from the attacking wind forces.

Preferably, the rotor hub is arranged as a hollow cylinder. Such a hollow cylinder can be placed on a corresponding journal (which on its part is rigidly arranged on the building), thus forming a rotary bearing. Roller bearings can be used for reducing the friction and/or fixing the rotor to the pin.

Preferably, a rotor blade is fixed to the rotor hub with its edge disposed on the inside, e.g. it is received by a corresponding longitudinal groove on the outside surface of the rotor hub in an interlocking fashion. This leads to a stable transmission of power or torque from the rotor blade to the rotor hub. In particular, the rotor blade is fixed to the rotor hub with its edge disposed on the inside substantially over its entire height.

According to a preferred further development it is provided that the inside edge of a rotor blade extends in a straight line and parallel to the rotational axis, while the outside edge of the rotor blade is oriented in a straight line and skewed relative to the rotational axis. Such an arrangement or alignment of the edges improves, among other things, the homogeneity of the pressure distribution on a rotor blade.

It is preferably preferred that a rotor blade is fixed to the rotor hub under a dihedral angle which is smaller than 90°. The surface section of a rotor blade which is disposed radially to the inside thus does not open perpendicularly, i.e. in the direction towards the rotational axis, into the rotor hub. This can be illustrated very easily when a tangent is applied to the outside surface of the rotor hub or a tangent surface is applied along the fixing line or longitudinal groove. The rotor blade is pitched directly at the rotor hub in the direction of the inflowing wind or against the direction of rotation of the rotor, with the pitch angle (relating to the imaginary tangent or tangent surface) being in the range of 50° to 70° and preferably being approximately 60°. This leads, among other things, to an improved transmission of power or torque transmission from the rotor blade to the rotor hub.

It is further preferably provided that the downwardly disposed edge of a rotor blade is provided with a straight arrangement, with this detail on shape relating predominantly to a planar shadow or projected surface of the rotor blade. It is also provided that the upwardly disposed edge of a rotor blade is provided with a straight configuration. It also preferable that both the upwardly disposed as well as downwardly disposed edge of a rotor blade is oriented or aligned in a substantially perpendicular way, relating to the rotational axis of the rotor.

According to an advantageous further development, a rotor blade is provided with a concave arrangement relating to the wind inflow direction between its inwardly disposed edge and its outwardly disposed edge. The rotor blade is preferably provided with a concave arrangement over its entire height, i.e. between its downwardly disposed edge and its upwardly disposed edge.

According to an also advantageous further development, a rotor blade is arranged as a thin-walled, freely shaped molded part with substantially constant wall thickness. Despite the low weight, high stability (or stiffness and strength) is obtained for the rotor blade which is the result of using the surface.

In order to increase the stability of a rotor blade, it is additionally provided that the same is provided with a stiffening portion on its bottom or upper edge, or simultaneously on both edges. The stiffening portion can be arranged for example as a U-profile enclosing these edges. Preferably, the stiffening portion extends radially from the inside to radially to the outside over approximately two-thirds up to three-fourths of the edge length.

It is further advantageous when a rotor blade comprises a beveled or rounded corner between its outwardly disposed edge and its upwardly disposed edge. It is also advantageous when a rotor blade comprises a beveled or rounded corner between its outwardly disposed edge and its downwardly disposed edge. Among other things, disadvantageous turbulences can be reduced which are caused by sharp edges, which also leads to oscillations. The noise generation by the rotor can also be reduced.

Preferably, the rotor blade is made from a fiber composite, especially a fiber composite with natural fibers and a bonding agent. This leads to an exceptionally light rotor blade which dampens oscillations and noises and which still offers high stability.

It is especially preferred that the rotor in accordance with the invention comprises seven or nine rotor blades which are arranged in a substantially similar way and which are arranged at the same angular distances about the rotor hub. Simulations and tests have shown that high efficiency can be achieved by precisely this number of rotor blades, with a still acceptable amount of generated turbulences. This also contributes to a low noise generation.

The wind power plant in accordance with the invention for mounting on a building, especially roof mounting, comprises a rotor according to at least one of the embodiments as explained above.

A preferred further development of the wind power plant in accordance with the invention comprises a wind deflector or a draft stop which is used at least partly for covering the rotor blades moved back against the direction of the wind and thus screens its rear surfaces from the inflowing wind. Preferably, this wind deflector is arranged in the form of a half-shell of a pipe which covers the jacket surface of an imaginary cylinder circumscribing the entire rotor at least along half the circumference. The height of the wind deflector preferably corresponds approximately to the height of the rotor blades. The efficiency of the wind power plant can thus be increased significantly in this way. It is especially provided that the wind deflector aligns itself depending on the direction of the wind. Preferably, the wind deflector is also made from a fiber composite, especially with natural fibers.

At least one generator advantageously belongs to the wind power plant in accordance with the invention, which generator converts the kinetic energy generated by the rotor into another form of energy, especially electricity. It is provided that this generator is not arranged in the direct vicinity of the rotor, but is remote form the same, i.e. at a predetermined distance, preferably in the vertical direction of the rotational axis of the rotor. The transmission of the kinetic energy from the rotor to the generator occurs by means of a transmission device, especially a drive shaft. Such a transmission device can comprise one or several drive shafts and gearing components. Drive shaft shall be understood as being any axially arranged device which is suitable for mechanical transmission of rotations (or torques). Gearing components can be cardan joints, directional reversers and torque converters.

Such a transmission device can also transmit the kinetic energy from a rotor to several generators or from several rotors to one or several generators.

It is especially preferable in this respect that the generator is arranged in the roof area of a building where it is protected from weathering influences and is easily accessible for maintenance purposes. Static advantages are also obtained by such an arrangement of the generator. The transmission device is received at least partly by a receiver and/or guided in the same. It is preferably provided that this receiver is used simultaneously for fixing the rotor (or rotors) to the roof of the building (or the like), which thus substantially reduces the mounting work for the wind power plant. In a preferred embodiment, such a receiver is a pipe, especially one with a circular diameter.

The invention shall be explained below in closer detail by reference to an especially preferred embodiment shown in the drawings. The drawings are included fully in the scope of disclosure, which especially also applies to the illustrated features which are not explained in closer detail in the text, wherein:

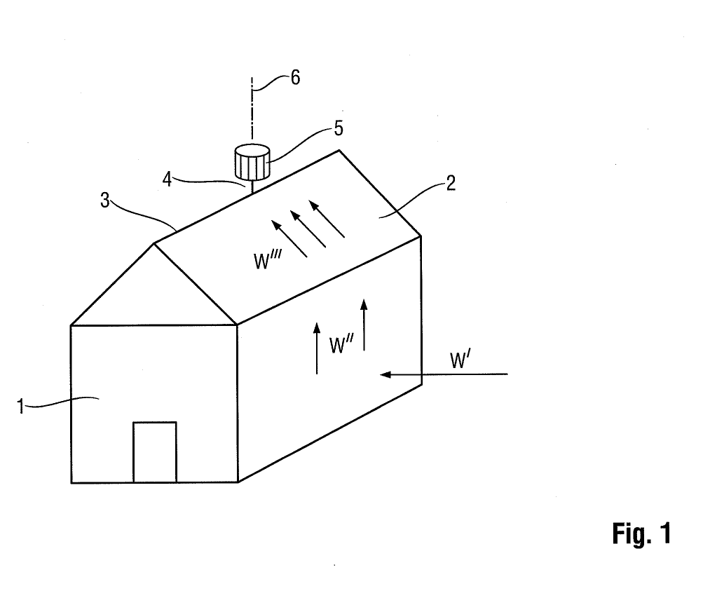

FIG. 1 shows a schematic principal diagram of a wind power plant arranged on a building;

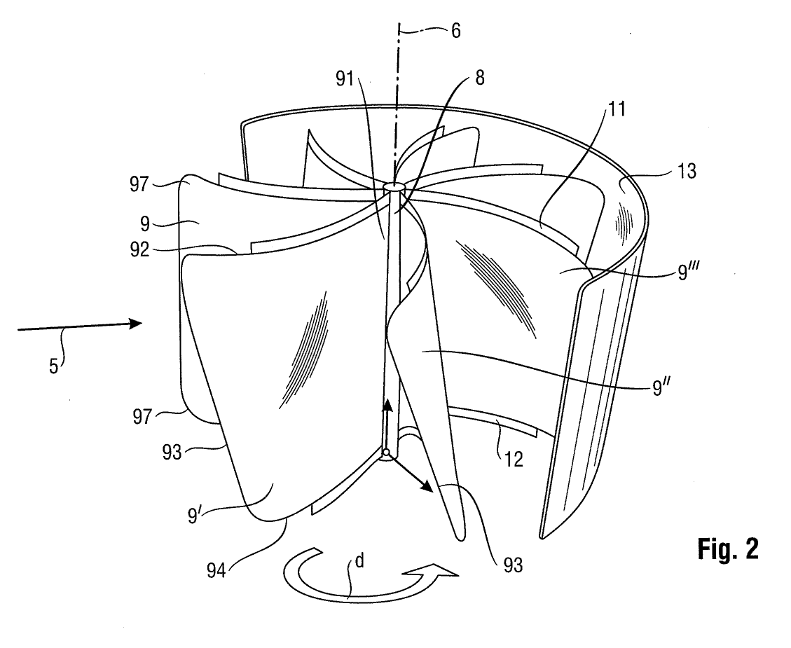

FIG. 2 shows a rotor in accordance with the invention in a perspective side view;

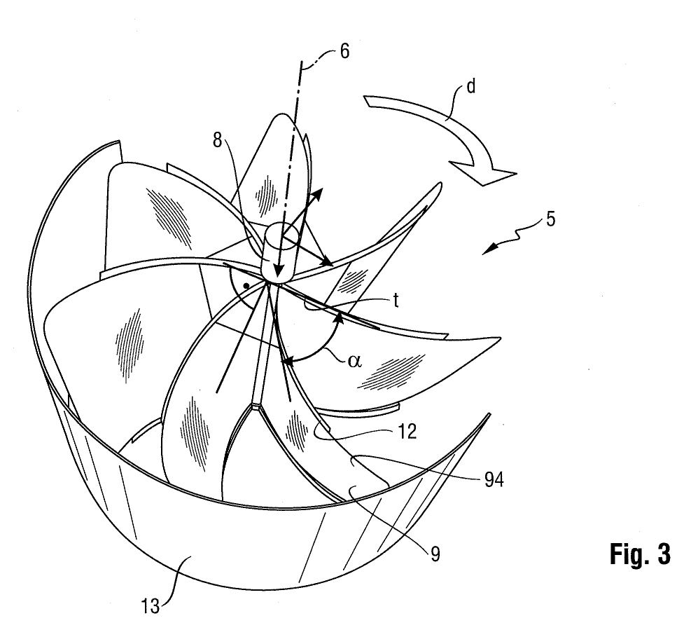

FIG. 3 shows the rotor in accordance with the invention of FIG. 2 in a perspective bottom view;

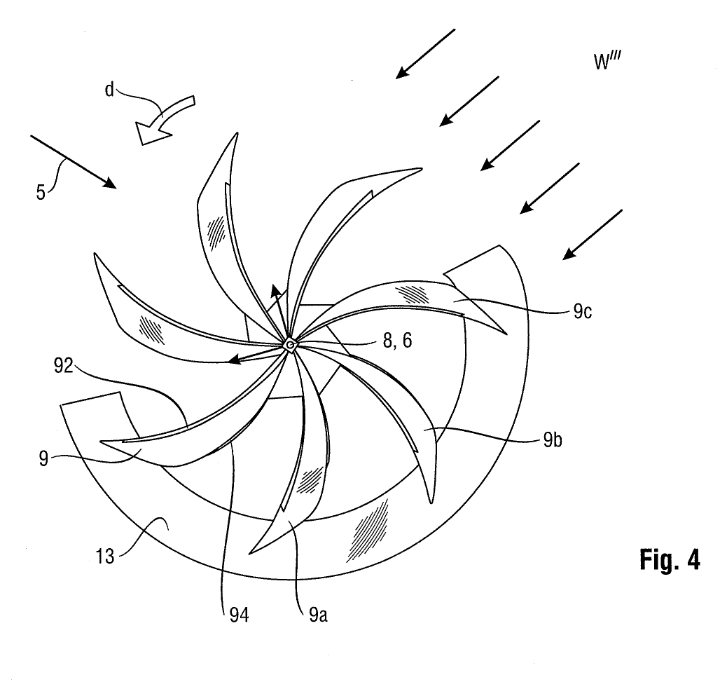

FIG. 4 shows the rotor in accordance with the invention of FIG. 2 in a perspective top view;

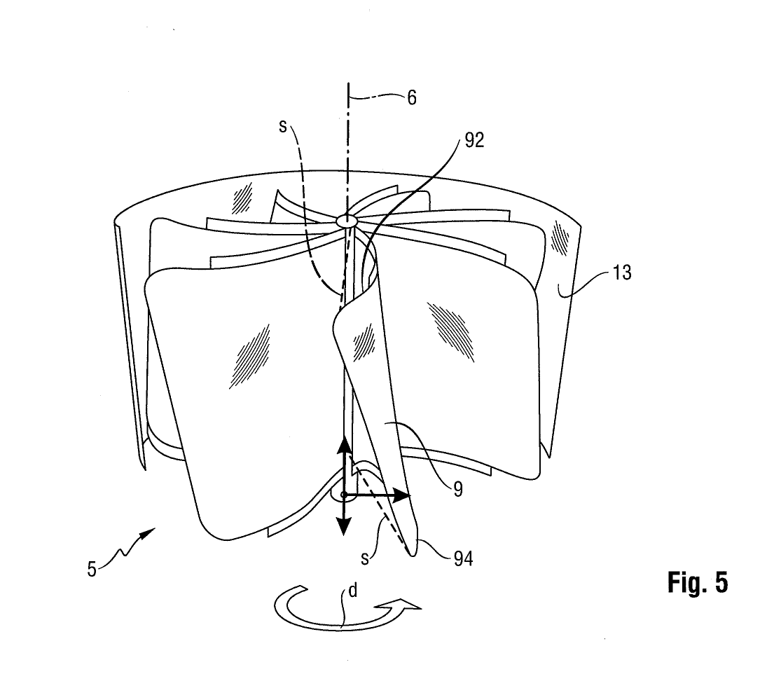

FIG. 5 shows the rotor in accordance with the invention of FIG. 2 in a perspective side view;

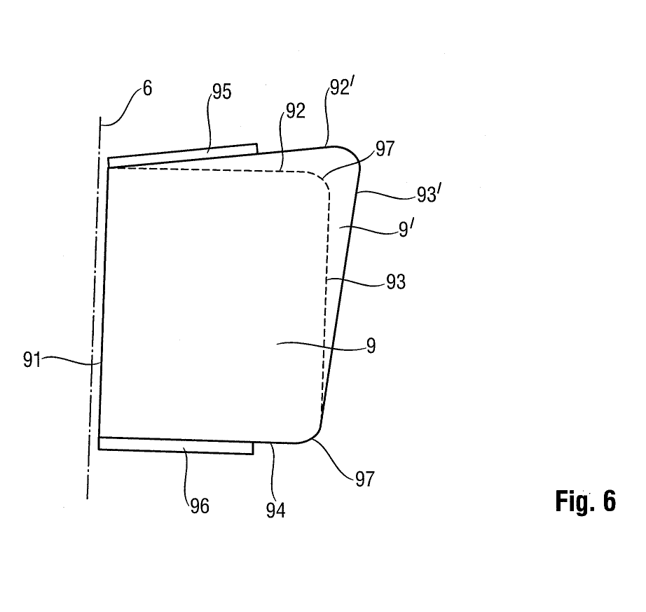

FIG. 6 shows the developed view of a rotor blade according to FIG. 2 in the plane, and

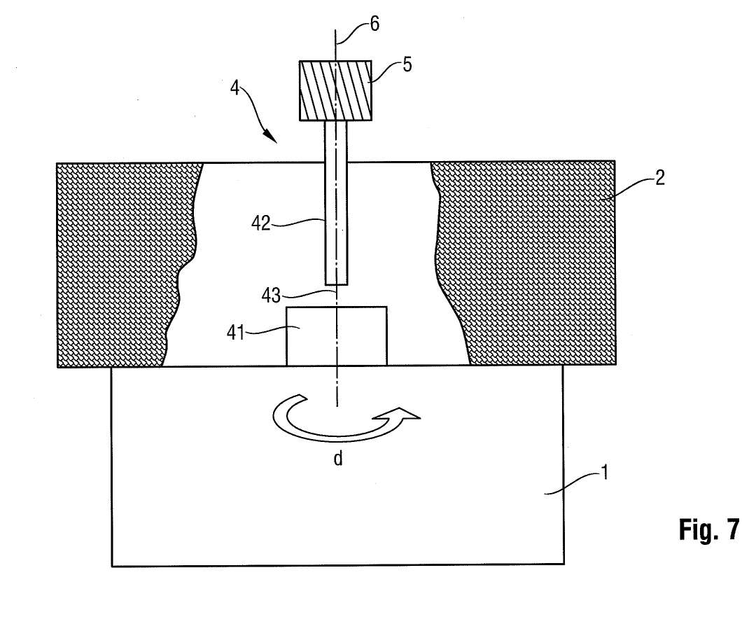

FIG. 7 shows a schematic side view of the building according to FIG. 1 with a roof partly cut open.

FIG. 1 shows a building designated with reference numeral 1 and comprising a roof, which in this case is a gable roof 2. Building 1 is subject to a wind flow w′. When the wind flows past the building, an acceleration of the wind flow or wind occurs as a result of the flow, which is indicated by arrows w″ and w″′ and which reaches its maximum at the ridge of the roof. In order to exploit these high wind speeds, a wind power plant designated with reference numeral 4 is arranged on the ridge 3 of the roof, which power plant comprises a rotor 5 which is rotatable about a vertical axis 6. A preferred embodiment of the rotor 5 is described below in closer detail in connection with FIGS. 2 to 6.

FIG. 2 shows the rotor 5 in accordance with the invention in a preferred embodiment. It comprises a rotor hub 8 which is arranged as a hollow cylinder and can be placed on a journal of a shaft (not shown), thus forming a rotary bearing. The rotor 5 comprises seven rotor blades 9 which are arranged on or fixed to the rotor hub 8 at the same angular distances. The direction of rotation d of the rotor (see illustration of arrow) is predetermined by the shape of the rotor blade which will be explained below in closer detail.

The rotor blades 9 are arranged with a fully covered configuration and have a substantially rectangular shape, which is clearly shown by the rotor blade designated with reference numeral 9″′. The indication “rectangular” relates to a direct frontal view of such a rotor blade (or a respective shadow or projected surface). Each rotor blade comprises an inwardly disposed edge (inside edge) 91, an upwardly disposed edge (upper edge) 92, an outwardly disposed edge (outside edge) 93 and a downwardly disposed edge (bottom edge) 94, which are arranged in a straight manner relating to the rectangular shape. This provides that the upwardly disposed edge 92 and the downwardly disposed edge 94 are oriented in a rectangular fashion relating to the rotational axis 6. In the corner regions between the upper edges 92 and the outside or outwardly disposed edges 93, the rotor blades are provided with a rounded portion 97, through which turbulences in this region are reduced. The same applies to the corner regions between the bottom edges 94 and the outside edges 93.

The rotor blades 9 are fixed to the rotor hub 8 along a straight line parallel to the rotational axis 6, which can be recognized very well in the illustrated cavity between rotor blades 9′ and the 9″. As is also clearly shown in FIG. 2, the rotor blades 9 are arranged as thin-walled, freely shaped molded parts of substantially constant wall thickness.

Starting from its bottom edge 94 in the direction towards its upper edge 92, each rotor blade 9 is twisted in a spiral fashion about the rotor hub 8. As a result, the rotor blades face the wind coming in via the incline of the roof to a higher degree, thus improving the efficiency of the wind power plant 4. As a result of this even (in the sense of continuous) spiral twisting of the rotor blades 9, the outside edges 93 of the rotor blades 9 are oriented in a skewed manner relative to the rotational axis 6, which can now be recognized very well with the rotor blade designated with 9″. Moreover, each rotor blade 9 comprises a concave bulging in the rotational direction between its inside edge 91 and its outside edge 93, which bulging is arranged over the entire height of the rotor blade, i.e. between the bottom edge 94 and the upper edge 92. This concave arrangement, when seen in the cross section, leads to a spiral arm structure of the rotor (perpendicular to the rotational axis 6), which is shown clearly in the FIGS. 3 and 4 which will be explained below in closer detail.

The rotor blades 9 are provided with a stiffening portion at their upper edges 92 and at their bottom edges 94, which stiffening portion covers the respective edges at least over a part of their length. A stiffening portion that would lead too far to the outside would strongly increase the moment of inertia of the rotor disproportionately, which would have a considerably adverse effect on its response behavior (capacity of reaction to changes in wind speed).

FIG. 2 further shows a wind deflector 13 which belongs to the wind power plant 4 and which covers the rear surfaces of the rotor blades which are moved back against the inflowing wind, thus significantly increasing the efficiency of the wind power plant (otherwise the rotor blades would work predominantly against one another). The height of the wind deflector 13 approximately corresponds to the height of the rotor blades 9 (meaning the vertical distance between the bottom edges 94 and the upper edges 92).

FIG. 3 shows the rotor in accordance with the invention in a perspective view from below. The hollow-cylindrical arrangement of the rotor hub 8 can clearly be seen as well as the arrangement of the seven rotor blades 9 at the same angular distances on the rotor hub 8. This illustration also shows the spiral arm structure of rotor 5 very clearly, which structure has already been explained above. The stiffening portions 12 for the bottom edges 94 of the rotor blades 9 are also clearly shown. All stiffening portions 12 can be arranged on a ring disposed radially to the inside, thus enabling an integral configuration. The same applies to the stiffening portions 11 on the upper edges 92 of the rotor blades 9.

The incidence of the rotor blades 9 relative to the rotor hub 8 is also shown with the help of subsidiary lines. The inner surface section of a rotor blade 9 does not open perpendicularly into the rotor hub 8, but relating to a tangent t under a dihedral angle or angle of incidence which is smaller than 90° and is approximately 60°. This leads to a more stable fastening of the rotor blade 9 to the rotor hub 8 and to a more effective transmission of power and moment.

FIG. 4 shows the rotor 5 in accordance with the invention in a perspective top view. It is clearly shown that as a result of the rotor blades 9 which are twisted in a spiral fashion about the rotor hub 8 their bottom edges 94 are in advancement over the upper edges 92, relating to the direction of rotation d. It is further shown that the wind deflector 13 is also formed as a thin-walled, freely shaped molded part and approximately has the shape of half a pipe or half-shell of a pipe. In the case of inflowing wind designated with reference numeral w″′, the rear surfaces of the rotor blades 9a, 9b and 9c which are moved back by against this direction of wind w″′ are screened. Preferably, this wind deflector 13 will align itself automatically depending on the direction of the wind, for which purpose it is rotatably held on the wind power plant (4) (not shown).

FIG. 5 shows the rotor 5 in accordance with the invention in a perspective side view which is substantially identical to that of FIG. 2. The wind deflector 13 is located here in another position, which is behind the rotor 5. The concave arrangement of the rotors 5 is shown very clearly in this view, with a secant s each being shown with a broken line for reasons of improved illustration on the upper edge 92 and the bottom edge 94 of the rotor blade 9 closest to the observer. With the supplementary illustration of the secants s it is clearly shown how the rotor blade 9 is arranged in a spiral fashion twisted about the rotor hub 8 starting from its bottom edge 94 in the direction of the upper edge 92 and, in this configuration, comprises a concavity which is arranged substantially the same over the height. The illustration of FIG. 5 further clearly shows the skewed angle of the outwardly disposed or outside edge 93 relative to the rotational axis 6, which is preferably in a range of 10° to 20° and is here approximately 15°, 16° or 17° (with each of these individual values being especially preferred).

A rotor blade 9 of the above described embodiment as developed in the plane would have the shape shown in FIG. 6 which substantially corresponds to a trapezoid. From such a blank, the rotor blade 9 could be formed from a sheet material for example. By forming the blank 9′, the rectangular shape would be obtained which is shown with the broken line and has already been described above and in which the outside edge 93 (previously 93′) is parallel to the rotational axis 6 and the upper edge 92 (previously 92′) and the bottom edge 94 are substantially perpendicular to the rotational axis 6. The strip 95 provided on the upper edge 92 is used for fixing the upper stiffening portion 11. The strip 96 provided on the bottom edge 94 is used for fixing the bottom rotor blade stiffening portion 12.

FIG. 7 shows the building 1 of FIG. 1 in a schematic side view with a roof 2 partly cut away. In the roof region of the building 1, i.e. within this building 1 and thus protected from weathering influences and the wind, a generator 41 is arranged which is connected by means of a drive shaft 43 with the rotor 5 arranged on the roof 2, such that the kinetic energy can be transmitted along the rotational axis 6 from the rotor 5 to the generator 41 (according to the direction of rotation d). Any possible cardan joints and gearings along the drive shaft 43 are not shown. It is preferably provided that the generator 41 is arranged directly below the rotor 5, as a result of which a simply arranged and substantially straight drive shaft 43 can be used, which saves costs and mounting work. Preferably, this drive shaft 43 is arranged as a circular-cylindrical or ring-cylindrical rod or hollow rod. The drive shaft 43 extends partly through a receiver 42, through which the drive shaft 43 is guided and protected. The receiver 42 is fastened to the building 1. Preferably, this receiver 42 is formed by a conventional pipe (e.g. with a circular cross section). The receiver 42 is also used for fastening the rotor 5 to the roof 2 of the building 1, thus leading to an exceptionally simple mounting of the wind power plant 4 on the building 1 or roof 2. The wind power plant 4 in accordance with the invention is therefore especially also suitable for retrofitting. The use of a drive shaft which is received in a receiver, with the receiver simultaneously being used for fastening the rotor, is not limited, in accordance with the invention, to the roof mounting of the wind power plant which is shown here.

1. A rotor for a wind power plant for mounting, preferably roof mounting, on a building, especially with a vertical rotational axis, comprising a rotor hub which encloses the rotational axis and at least one rotor blade, wherein the rotor blade is arranged to cover the whole surface area and has a substantially rectangular shape, comprising a radially inwardly disposed edge, a radially outwardly disposed edge, a radially extending bottom edge and a radially extending upper edge, with said rotor blade being provided with a twisted arrangement in a spiral fashion about the rotor hub, starting from its bottom edge in the direction of its upper edge.

2. A rotor for a wind power plant according to claim 1, wherein the rotor blade is fastened with its inwardly disposed edge to the rotor hub, preferably over its entire height.

3. A rotor for a wind power plant according to claim 1, wherein the inwardly disposed edge of the rotor blade extends in a straight line and parallel to the rotational axis and the outwardly disposed edge extends in a straight line and skewed relative to the rotational axis.

4. A rotor for a wind power plant according to claim 1, wherein the rotor blade is fastened to the rotor hub under a dihedral angle which is smaller than 90°.

5. A rotor for a wind power plant according to claim 1 wherein the bottom edge and/or the upper edge of the rotor blade is provided with a straight arrangement, and is/are oriented in a substantially rectangular manner relative to the rotational axis.

6. A rotor for a wind power plant according to claim 1, wherein the rotor blade is provided with a concave arrangement between its inwardly disposed edge and its outwardly disposed edge, preferably over its entire height.

7. A rotor for a wind power plant according to claim 1, wherein the rotor blade is arranged as a thin-walled, freely shaped molded part with substantially constant wall thickness.

8. A rotor for a wind power plant according to claim 1, wherein the rotor blade comprises a stiffening portion on its bottom edge and/or its upper edge.

9. A rotor for a wind power plant according to claim 1, wherein the rotor blade comprises rounded corners between its outwardly disposed edge and its upwardly disposed edge and/or its downwardly disposed edge.

10. A rotors for a wind power plant according to claim 1, wherein the rotor blade is made from a fiber composite, especially with natural fibers.

11. A rotor for a wind power plant according to claim 1, wherein it comprises seven or nine substantially similarly arranged rotor blades which are arranged about the rotor hub in the same angular distances.

12. A wind power plant for mounting, especially roof mounting, on a building, comprising a rotor according to claim 1.

13. A wind power plant (4) according to claim 12, wherein it comprises a wind deflector, preferably in the form of a half-shell of a pipe, for covering the rotor blades moved back against the direction of the wind.

14. A wind power plant (4) according to claim 12, wherein it comprises at least one generator which is arranged remote from the rotor and is driven by the rotor by means of a transmission device, especially a drive shaft.

15. A wind power plant according to claim 14, wherein the generator is arranged in the roof area of the building and the transmission device is arranged at least partly within a receiver which is also used for fastening the rotor.
